(19) United States
(12) Patent Application Publication
(10) Pub. No.: US 2026/0054468 A1
(43) Pub. Date: Feb. 26, 2026

(54) LIGHTWEIGHT COMPOSITE PANELS AND COMPOSITIONS AND METHODS FOR MANUFACTURING AND USING SAME

(71) Applicant: HYDROBLOK, INC., Park City, UT (US)

(72) Inventors: Zhongsheng CHEN, Draper, UT (US); Brian DUNN, Draper, UT (US); Alex GILLESPIE, Draper, UT (US)

(21) Appl. No.: 19/306,608

(22) Filed: Aug. 21, 2025

Related U.S. Application Data
(60) Provisional application No. 63/686,489, filed on Aug. 23, 2024.
(60) Provisional application No. 63/692,563, filed on Sep. 9, 2024.
(60) Provisional application No. 63/720,649, filed on Nov. 14, 2024.
(60) Provisional application No. 63/729,637, filed on Dec. 9, 2024.

(51) Int. Cl. B32B 13/04; B32B 5/18; B32B 13/12; B32B 27/42; B32B 37/00

(52) U.S. Cl. CPC B32B 13/045; B32B 5/18; B32B 13/12; B32B 27/42; B32B 37/00; B32B 2250/03; B32B 2250/40; B32B 2266/0214; B32B 2375/00; B32B 2607/00

(57) ABSTRACT

Lightweight composite panels, compositions used to make lightweight composite panels, and methods for manufacturing lightweight composite panels. The lightweight composite panels include a lightweight foam core sandwiched between thin protective layers selected from fiber mesh reinforced cementitious layer and thermoset polymer layer, e.g., polyurea or polyaspartic. The lightweight composite panels can be used in place of conventional wallboards and panels, including for various uses such as interior drywall, backer boards for tile and other interior finishes, including those exposed to moisture, exterior sheathing, floor underlayment, soffits, roofing decks, shaft liners, and the like. The lightweight composite panels can be cut, drilled, and screwed onto structural elements of buildings, such as wall frames comprising wooden or metal studs, roof frames comprising boards, studs, or trusses, floor joists, concrete floors, foundations, and the like. Exterior sheathing panels can include a drainage layer and/or a factory installed finish.

### CROSS-REFERENCE TO RELATED APPLICATIONS

This application claims the benefit of U.S. Provisional Application No. 63/729,637, filed Dec. 9, 2024, U.S. Provisional Application No. 63/720,649, filed Nov. 14, 2024, U.S. Provisional Application No. 63/692,563, filed Sep. 9, 2024, and U.S. Provisional Application No. 63/686,489, filed Aug. 23, 2024, which are incorporated by reference in their entirety.

### BACKGROUND

### Technical Field

This disclosure relates to lightweight composite panels and compositions and methods for making and using lightweight composite panels and variations thereof.

### Related Technology

Houses and other buildings are typically constructed using wood or metal studs to form a three-dimensional wall frame, which can include an interior wall on one side and an exterior wall on the other. Alternatively, both sides can be interior walls, such as interior walls separating rooms or walls dividing attached dwelling units such as apartments, town houses, and condominiums. In some cases, both sides can be exterior walls, such as fences, screen walls, sound barriers, walls that partially enclose carports, dumpster surrounds, and the like.

Interior walls of houses and other buildings are typically formed using drywall (e.g., gypsum board) to form a generally flat underlying wall surface, which can be painted, wallpapered, or treated with other desired finishes. A drywall panel typically consists of a layer of gypsum plaster sandwiched between two layers of paper. Gypsum plaster is made from calcium sulfate hemihydrate (or plaster of Paris) and water and mixed with fiber (typically paper and/or glass fiber), plasticizer, foaming agent, finely ground gypsum crystal as accelerator, EDTA, starch or other chelate as a retarder, and various additives that can increase mildew and fire resistance, lower water absorption (wax emulsion or silanes), and reduce creep (tartaric or boric acid). The board is then formed by sandwiching a core of the wet plaster mixture between two sheets of heavy paper or fiberglass mats. When the core sets, it is dried in a drying chamber, and the sandwich becomes rigid and strong enough for use as a building material.

While suitable for walls which are not exposed to water, drywall is not suitable for applications exposed to water and high humidity environments. Drywall is highly vulnerable to moisture due to the inherent properties of the materials that constitute it: gypsum, paper, and organic additives and binders. Gypsum will soften with exposure to moisture and turn into a gooey paste with prolonged immersion, such as during a flood or even in a bathroom when exposed to excessive water. Following water damage, drywall will likely need to be removed and replaced. Furthermore, the paper facings and organic additives mixed with the gypsum can be a breeding ground for mold.

For applications where walls will be exposed to moisture, such as in bathrooms, particularly showers and bathtubs, cement board is typically used. Cement board is a combination of cement and reinforcing fibers formed into sheets of varying thickness. They are typically used as backer board for tile and other finishes. Cement board can be nailed or screwed to wood or steel studs to create a substrate for vertical tile and attached horizontally over plywood for tile floors, kitchen counters, and backsplashes. Cement board can also be used on the exterior of buildings as a base for exterior plaster (stucco) systems and sometimes as the finish system itself. Cement board adds impact resistance and strength to the wall surface as compared to gypsum boards. Cement board can be fabricated in thin sheets with polymer modified cements to allow bending for curved surfaces.

As tile backer board, cement board has better long-term performance than paper-faced gypsum core products because it does not physically break down in the continued presence of moisture or leaks and purportedly does not support mold or mildew growth. Cement board does provide a stronger bond and support with tiles than typical gypsum board. Cement board is typically made to breath and is not waterproof per se. It can absorb moisture but has excellent drying properties. In areas continually exposed to water (e.g., showers) a waterproofing material (e.g., plastic barrier) is usually placed behind the boards or a trowel-applied waterproofing product (e.g., liquid membrane) can be applied to the face of the boards behind the finish system.

A major disadvantage of cement board is its relative high density (e.g., weight per square foot). Cement board weighs approximately twice as much as gypsum board, making handling by one person difficult. Cutting of cement board must also be done with carbide-tipped tools and saw blades. Due to its hardness, pre-drilling of fasteners is often recommended. And because cement board contains fibers and many voids, pockets, and capillaries, it does in fact permit water penetration and can even support mold growth.

Exterior walls and wall finishes have their own unique challenges. In general, exterior walls are typically formed by fastening sheathing, typically wooden boards, to form exterior walls, followed by the application of a waterproof membrane, followed by the application of one or more surface finishes, most of which require several steps and layers. The wooden sheathing boards can be any kind of plywood. The currently preferred and most common wooden sheeting used to make exterior walls are oriented strand board (“OSB”) panels because of their favorable cost and combination of materials properties. OSB panels are typically used to form outer walls to which desired finishing elements can be attached, such as stucco, bricks, stone, panels, fixtures, and the like.

OSB panels are not waterproof but prone to swelling, rotting, and developing mold and mildew if exposed to water over time. They are typically wrapped with a waterproof polymer membrane to keep external water from contacting the OSB panels. The waterproof polymer membrane can also provide an air barrier that prevents unwanted air leakage. In addition, flashing, tape, and sealants can be used around joints to prevent water and air intrusion. Thereafter, one or more layers of other materials are applied over the polymer membrane to form a finished outer wall. At least one of the outer layers must be mechanically attached or connected to OSB panels to provide structure to hold the outer layers in place. Penetration of nails and screws through the waterproof polymer membrane, however, can potentially compromises its integrity and provide a pathway for moisture intrusion.

Another issue is that OSB panels are flammable and emit toxic gases when ignited, such as during house fire. Moreover, burning OSB panels emit embers that can quickly spread and ignite other fires, such as those which devastated entire neighborhoods near Los Angeles, California, in January 2025.

Accordingly, there remains a need for wallboards, sheathing, and other structural panels and underlayments that are waterproof, provide high strength, are lightweight to facilitate installation, and are resistant to combustion.

### SUMMARY

Disclosed are lightweight composite panels, compositions for making lightweight composite panels and variations thereof, and methods of manufacturing and using lightweight composite panels and variations thereof. The lightweight composite panels can be used in place of conventional wallboards and panels, including for a variety of uses such as interior drywall, backer boards for tile and other interior finishes, including those exposed to moisture, exterior wall sheathing or cladding and finishes applied thereto, floor underlayment, soffits, roofing decks and roof elements applied thereto, shaft liners, and the like.

The lightweight composite panels comprise a lightweight foam core sandwiched between first and second protective layers selected from a fiber mesh reinforced cementitious composition, cured thermoset resin, or other rigid material. The lightweight composite panels can be cut, drilled, and screwed onto structural elements of buildings, such as wall frames comprising wooden or metal studs, roof frames comprising boards, studs, or trusses, floor joists, concrete floors, foundations, and the like.

In some embodiments, one or more protective layers of the lightweight composite panels may comprise a fiber mesh reinforced cementitious composition. As a result, the lightweight composite panels are strong and can support relatively heavy loads using nails, screws, and other fasteners known in the art. Protective layers made from fiber mesh reinforced cementitious composition can be “thin” (e.g., typically less than about 3 mm, less than about 2.5 mm, less than about 2 mm, or less than about 1.5 mm, such as about 1 mm, in cross-sectional thickness), are lightweight yet waterproof and have high structural strength (i.e., high tensile and flexural strength and high toughness). The fiber mesh component is typically fiberglass fiber or filament mesh but can be made of other strong fibers or filaments, such as carbon fibers or filaments.

In addition to, or instead of, a fiber mesh reinforced cementitious layer, one or both protective layers of the lightweight composite panels may comprise other materials in addition to or instead of the fiber mesh reinforced cementitious composition. Examples include one or more of rigid magnesium oxide material, water-resistant polymer, or a composite material comprising a resin or polymer with embedded fibers, fiber mesh, fabric, woven, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

The lightweight foam core is typically made from extruded polystyrene foam (XPS) but can alternately comprise expanded polystyrene foam (EPS), polyisocyanurate foam, polyurethane (PUR) foam, phenolic polymers (e.g., phenol-formaldehyde) melamine polymers (e.g., melamine-formaldehyde), and/or other thermoplastic and thermoset polymers known in the art that can be formed into rigid or semi-rigid foam layers.

Alternatively, the foam core may comprise an inorganic foam materials, such as a refractory foam material, to provide additional fire-resistance. Examples include silica gel, aerogel, silicate foams, urea-silicate foam, SiOC/SiC, ceramic foams, refractory foams, and the like. The inorganic foam core can resist melting even when exposed to fire or intense heat in order for the lightweight composite panel to maintain its structural integrity.

In some embodiments, lightweight composite panels are manufactured by applying a fiber (e.g., fiberglass) mesh and cementitious or curable resin composition onto front and back surfaces of a foam sheet, such as an XPS or other polymer foam core and causing or allowing the cementitious or curable resin composition to harden. The fiber mesh can be embedded in the cementitious or curable resin composition to enhance strength, increase toughness, and prevent cracking. In some embodiments, a fresh cementitious composition comprises mixture products of hydraulic cement, silicon dioxide powder, calcium oxide, iron oxide, plaster of Paris (gypsum hemihydrate), water-reducing agent, defoamer, styrene, and acrylic acid. The hydraulic cement typically includes Portland cement, but may also include supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The fresh cementitious composition may include other components, such as natural hydraulic lime, calcium silicate, and/or expanded glass, which can increase fire and heat resistance.

In some embodiments, the lightweight composite panels can be used as exterior sheathing. They can advantageously be modified by attaching a drainage layer (e.g., polymer uncoupling membrane, embossment, drainage plane, rain screen, dimple board, factory applied dimples or dots, or bleed layer (collectively “drainage layer”) to an interior surface, such as with a waterproof adhesive or directly adhered to the cementitious composition used to make the fiber mesh reinforced cementitious layer on the interior side facing a wall or roof frame. The drainage layer provides gaps and channels between the lightweight composite panels and the underlying wall or roof structure to permit moisture to collect and drain and/or evaporate, thereby protecting outer surface finishes and preventing or minimizing formation of mold, mildew, and structural damage of the underlying wall and/or exterior finish, such as by freeze-thaw cycles, delamination, or other water-related issues.

In some embodiments, the panels can include a pre-applied surface finish, such as stucco, thin bricks, natural and manufactured stone veneers, tiles, roofing shingles, wood shakes, metal cladding, and the like, on an exterior surface facing away from a wall or roof frame (e.g., adhered to the exterior fiber mesh reinforced cementitious layer). In such cases, the lightweight composite panels may also include the aforementioned drainage layer to facilitate removal of moisture between the lightweight composite panels and the underlying wall or roof structure.

The lightweight composite panels can be fastened to wall or roof structures of a building using mechanical fasteners and adhesives known in the art, such as wood screws, sheet metal screws, nails, rivets, and construction adhesive. Mechanical fasteners are advantageously corrosion resistant. Strips of tape can be used as a template to ensure proper placement of screws or other mechanical fasteners when fastening lightweight composite panels to studs or other structural elements of wall or roof structures. To prevent screws from tearing through the exterior fiber mesh reinforced cementitious layer, screws can be used with enlarged washers having high surface area to distribute the pressure or load over a high surface area of the lightweight composite panels. Specialized washers with penetrating prongs can be used (e.g., with screws) to limit rotation and penetration, preventing damage to the lightweight composite panels. Rectangular washers with multiple prongs on either side of the screw can be used to tie adjacent lightweight composite panels together. The penetrating prongs can have a length so that the washers lie flush with or just below the surface of the exterior fiber mesh reinforced cementitious layer. A patch coating can be applied over the washers to fill any indentations caused by the washers or other mechanical fasteners.

Additional features and advantages will be set forth in part in the description that follows, and in part will be obvious from the description, or may be learned by practice of the embodiments disclosed herein. It is to be understood that both the foregoing brief summary and the following detailed description are exemplary and not restrictive of the embodiments disclosed herein or as claimed

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A is a side perspective view that illustrates examples of differently-sized lightweight composite panels;

FIG. 1B is a top perspective view that illustrates the differently sized lightweight composite panels of FIG. 1A;

FIG. 2 is an exploded diagram that schematically illustrates the layered structure of the lightweight composite panels of FIGS. 1A and 1B;

FIG. 3 is a detailed flow chart that illustrates an example method of manufacturing lightweight composite panels;

FIGS. 4A-4C illustrate an embodiment of a specialized fastener assembly comprising a screw and specialized washer with multiple prongs designed to penetrate at least partially through and become embedded within the lightweight composite panels;

FIGS. 5A and 5B illustrate examples of lightweight composite panels for exterior use with an attached drainage layer with gaps or channels that facilitate removal of moisture from between the lightweight composite panel and an exterior wall or roof structure to which it is attached;

FIGS. 6A-6D illustrate alternative embodiments of drainage layers, variously known as uncoupling membranes, drainage planes, rain screens, dimple boards, or bleed layers, with gaps or channels that can be attached to lightweight composite panels to facilitate removal of moisture from between the lightweight composite panels and an exterior wall or roof structure to which they are attached;

FIG. 7 illustrates an outdoor system for applying a desired cladding or exterior finish to an exterior wall of a building and means (e.g., an air gap and metal flashing) for permitting air flow and removal of moisture from spaces between the cladding or exterior finish and the exterior wall;

FIG. 8 illustrates a lightweight composite panel with an applied stucco finish on the exterior fiber mesh reinforced cementitious layer;

FIG. 9 illustrates lightweight composite panels attached to a wall frame as sheathing using enlarged washers to form a wall with corners, fiber mesh and a corner bend applied over corners formed by adjacent panels, a seam coat covering the fiber mesh and corner bend, and an applied stucco finish over the seam coat;

FIG. 10 illustrates an exterior wall made using lightweight composite panels as sheathing with various applied exterior finishes, including stucco, stone, and tiles applied over exterior fiber mesh reinforced cementitious layers; and

FIG. 11 illustrates a lightweight composite panel with thin bricks applied to an exterior surface thereof for use as exterior sheathing with pre-applied finish.

### DETAILED DESCRIPTION

### I. Overview

Disclosed herein are lightweight composite panels that are strong, lightweight, moisture resistant, and heat resistant. Also disclosed are compositions and methods for manufacturing lightweight composite panels and variations thereof. Lightweight composite panels comprise a lightweight foam core sandwiched between first and second protective layers of fiber mesh reinforced cementitious and/or other rigid protective material. The lightweight foam core can be made of a polymer foam, such as closed cell polystyrene foam, to provide a water-resistant barrier that can, in some embodiments, can be 100% waterproof. The lightweight composite panels can be used in place of conventional wallboards and panels, including for a variety of uses such as interior drywall, backer boards for tile and other interior finishes, including those exposed to moisture, exterior wall sheathing and finishes applied thereto, floor underlayment, soffits, roofing decks and roof elements applied thereto, shaft liners, and the like.

The lightweight composite panels can be cut, drilled, and fastened to structural elements of buildings, such as wall frames comprising wooden or metal studs, roof frames comprising boards, studs, or trusses, floor joists, concrete floors, foundations, and the like. Because both sides comprise a fiber mesh reinforced cementitious composition, the lightweight composite panels are strong and can be nailed or screwed into and support relatively heavy loads, such as thin bricks, wall tiles, stone, stucco, roofing tiles, shingles, metal cladding, wood shakes, and other finishes applied thereto and/or fixtures or other items using nails, screws, or other fasteners known in the art. A drainage layer can be applied to an interior surface of the lightweight composite panels to facilitate removal of moisture from between the lightweight composite panels and the underlying wall or roof structure. The lightweight composite panels can be fastened to wall or roof structures of a building using mechanical fasteners and adhesives known in the art, such as wood screws, sheet metal screws, nails, rivets, and construction adhesive. Specialized washers with penetrating prongs can be used (e.g., with screws) to limit rotation and penetration, preventing damage to the lightweight composite panels.

### II. Lightweight Composite Panels

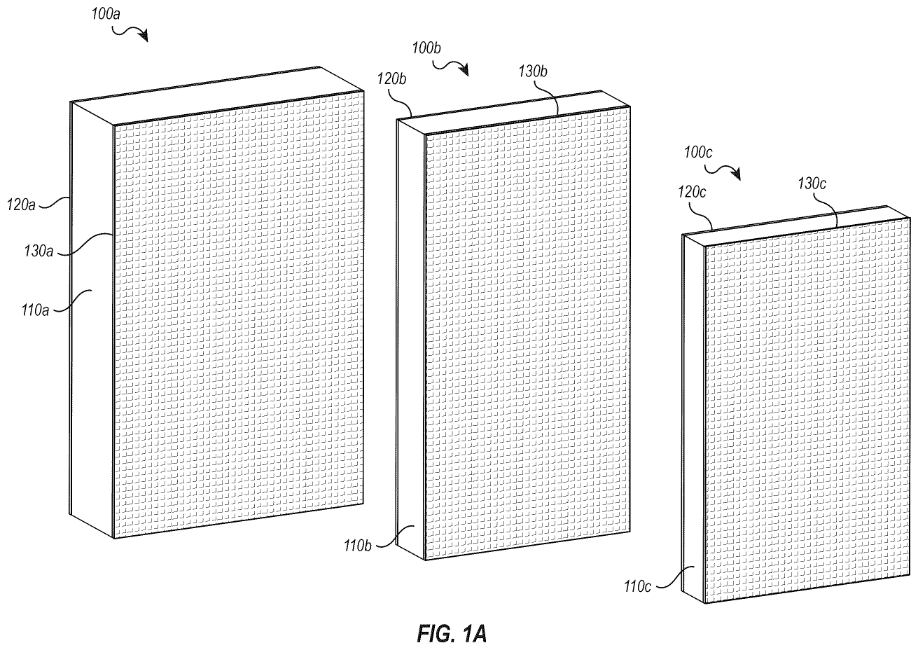

Reference is made to FIGS. 1-3. FIGS. 1A and 1B illustrate examples of lightweight composite panels 100a, 100b, 100c of varying cross-sectional thickness that can be used as is or modified with other features for a specific purpose. FIGS. 1A and 1B show the layered structure of the lightweight composite panels 100a, 100b, 100c, including strong, lightweight, and moisture-resistant extruded polystyrene (XPS) foam cores 110a, 110b, 110c sandwiched between first fiber mesh reinforced cementitious layers 120a, 120b, 120c and second fiber mesh reinforced cementitious layers 130a, 130b, 130c. As discussed below, in other embodiments the foam core may comprise other polymer or inorganic foam materials, and one or both protective layers may comprise a thermoset polymer or other rigid protective material.

The cross-sectional thickness of lightweight composite panels 100a, 100b, 100c can be selected based on a combination of desired properties for their intended use, such as strength, insulation, spacing between wall elements, and the like. As illustrated in FIGS. 1A and 1B, the cross-sectional thicknesses of the lightweight composite panels 100a, 100b, 100c varies mostly or entirely depending on the cross-sectional thickness of the foam cores 110a, 110b, 110c. Although not shown, when lightweight composite panels 100 of greater cross-sectional thickness are desired, it may be desirable to increase the thickness of the fiber mesh reinforced cementitious layers 120, 130 (e.g., to account for possible strength reduction caused by including a foam core 110 of greater cross sectional thickness).

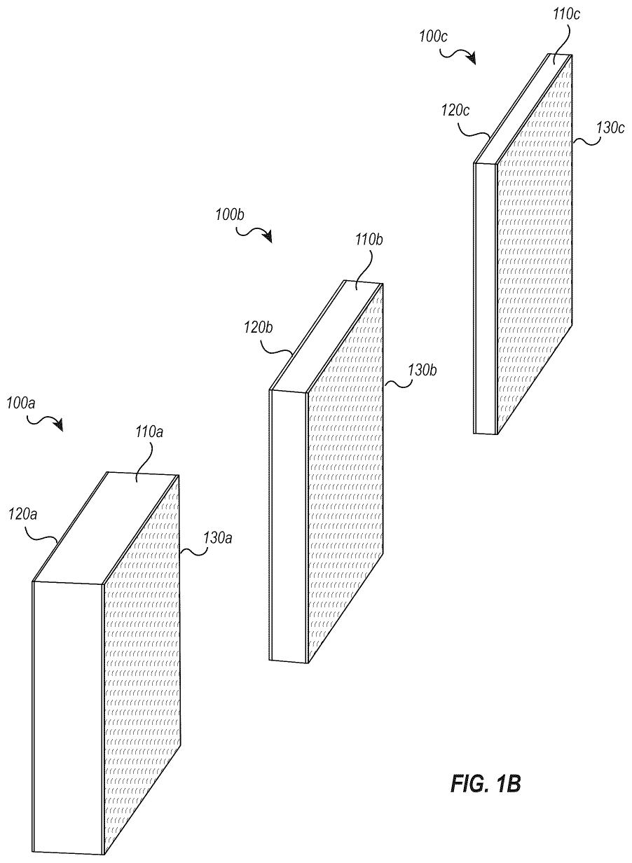

FIG. 2 is in an exploded view that schematically illustrates the layered structure of a core composite panel structure 200, which is similar or identical to the core composite panel structures 100a, 100b, 100c of FIGS. 1A and 1B. The foam core 210 can be a lightweight polymer foam made from closed cell extruded polystyrene (XPS), is lightweight, rigid, waterproof, thermally insulating, and includes two outer surfaces or faces. In some embodiments, the foam core 210 may have a density of about 30-45 kg/m³ and a compressive strength of about 250-400 kPa.

Alternatively, the foam cores 110, 210 discussed above can be made from a different polymer foam material, such as, but not limited to, expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. An advantage of thermoset polymer foam materials is they are generally more fire- and heat-resistant than thermoplastic polymers, with thermoset phenolic polymers in particular providing a high level of fire and heat resistance.

The properties of various polymers that can be used to make foam core layers 110, 210 are set forth in Tables 1-3.

TABLE 1

| Property | XPS/EPS | Phenolic | |
|---|---|---|---|
| Material Type | Thermoplastic | Thermoset (phenol- | |
| | polystyrene | formaldehyde) | |
| Thermal Conductivity (W/m · K) | 0.028-0.033 | 0.018-0.022 | |
| R-Value per inch | ~5.0 | 6.5-7.2 | |
| Fire Resistance | Poor - melts, drips | Excellent - chars, low | |
| | | smoke | |
| Flame Spread (ASTM E84) (W/O Facer | 75-200 | <25 (Class A) | |
| Smoke Development (W/O Facer) | >450 (often) | <50 | |
| Thermal Stability | ~93° C. (melts) | 150-175° | C. |
| Water Resistance | Excellent | Good (closed-cell) | |
| Compressive Strength | 200-300 kPa | 100-150 | kPa |

| | | |
|---|---|---|
| Flexural Strength | Flexible, good | Brittle |
| Recyclability | Yes (thermoplastic) | No |
| Weight (kg/m³) | 25-35 | 35-50 |
| Cost | Low-Moderate | High |

TABLE 2

| Property | Melamine | PUR | |
|---|---|---|---|
| Material Type | Thermoset (melamine- | Thermoset (polyol + | |
| | formaldehyde) | isocyanate) | |
| Thermal Conductivity (W/m · K) | 0.032-0.036 | 0.020-0.025 | |
| R-Value per inch | ~4.1-4.5 | ~6.0-6.5 | |
| Fire Resistance | Excellent - non- | Poor - needs FR | |
| | melting, self- | additives | |
| | extinguishing | | |
| Flame Spread (ASTM E84) (W/O Facer | <25 (Class A) | Varies (often >25) | |
| Smoke Development (W/O Facer) | Very low | High | |
| Thermal Stability | ~240° C. | ~100-120° | C. |
| Water Resistance | Poor unless sealed | Good | |
| Compressive Strength | Low | 150-300 | kPa |

| | | |
|---|---|---|
| Flexural Strength | Very brittle | Strong |
| Recyclability | Limited | No |
| Weight (kg/m³) | 7-12 | 30-45 |
| Cost | High | Moderate |

TABLE 3

| Property | Polyiso | |
|---|---|---|
| Material Type | Thermoset (polyisocyanurate) | |
| Thermal Conductivity (W/m · K) | 0.020-0.023 | |
| R-Value per inch | ~6.0-6.5 | |
| Fire Resistance | Good - chars, often Class A | |
| | with facer | |
| Flame Spread (ASTM E84) (W/O Facer | <25 (Class A with facer) | |
| Smoke Development (W/O Facer) | <150 | |
| Thermal Stability | ~150° | C. |
| Water Resistance | Fair (can degrade if | |
| | unprotected) | |
| Compressive Strength | 140-200 | kPa |

| | |
|---|---|
| Flexural Strength | Moderate |
| Recyclability | Rarely recycled |
| Weight (kg/m³) | 30-42 |
| Cost | Moderate-High |

With reference to FIG. 2, formed over first and second outer surfaces of the foam core 210 are first and second layers of fiber (e.g., fiberglass) mesh 220b, 230b, respectively, which become embedded within respective first and second layers of fresh cementitious composition applied over the fiber mesh layers 220b, 230b, which harden or cure to form first and second cementitious layers 220a, 230a. Together, the hardened cementitious layers 220a, 230a and embedded fiberglass mesh layers 220b, 230b form first and second fiber mesh reinforced cementitious layers 220, 230, which adhere to the foam core 210 to form a strong but lightweight composite panel structure. The fiber mesh layers 220b, 230b can alternatively include other fibers or filaments, such as carbon fibers or filaments.

The lightweight foam core is typically made from extruded polystyrene foam (XPS), but can alternately comprise expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. The lightweight foam core can be made of closed cell polystyrene foam to provide a water-resistant barrier (e.g., 100% waterproof).

Alternatively, the foam core may comprise an inorganic foam, such as a refractory foam material, to provide additional fire-resistance. Examples include silica gel, aerogel, silicate foams, urea-silicate foam, SiOC/SiC, ceramic foams, refractory foams, and the like. The inorganic foam core can resist melting even when exposed to fire or intense heat in order for the lightweight composite panel to maintain its structural integrity.

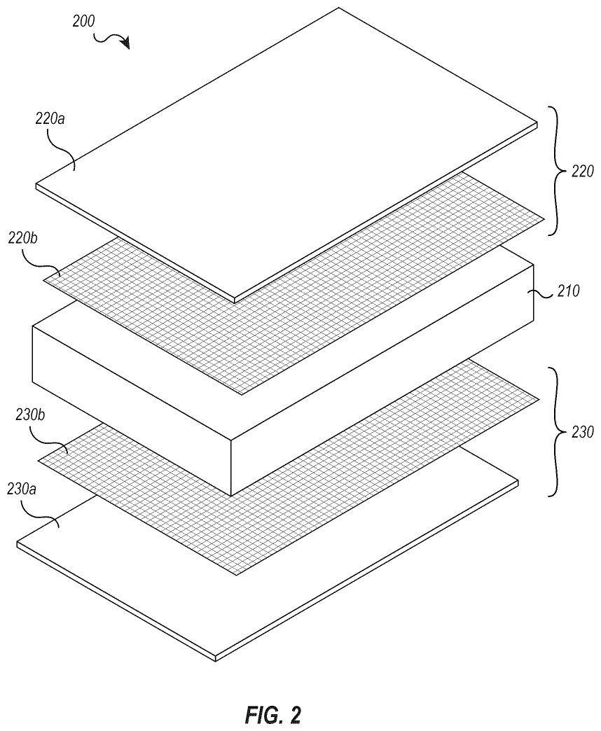

FIG. 3 is a process flow chart that illustrates an embodiment of a method of manufacturing lightweight composite panels. In some embodiments, the lightweight composite panels are manufactured by applying a fiber (e.g., fiberglass) mesh and fresh cementitious composition onto first and second surfaces of a rigid polymer (e.g., XPS) or inorganic foam core and causing or allowing the applied cementitious composition to harden. The fiber mesh becomes embedded in the hardened cementitious layer to enhance strength, increase toughness, and prevent cracking of the hardened cementitious layer. Alternatively, at least one of the hardened cementitious layers can be replaced or augmented with a cured polymer layer.

The layers of fiber mesh reinforced cementitious composition are generally “thin” (e.g., typically less than about 3 mm, less than about 2.5 mm, less than about 2 mm, or less than about 1.5 mm, such as about 1 mm, or between about 0.5-3 mm, about 0.75-2.5 mm, or about 1-2 mm in cross-sectional thickness). The fiber mesh reinforced cementitious layers can be very lightweight yet waterproof and have high structural strength (i.e., high tensile and flexural strength and high toughness). The fiber mesh component is typically fiberglass fiber or glass filament mesh, but can be made of other strong fibers or filaments, such as carbon fibers or filaments. In some embodiments, fiberglass mesh is formed of an alkali-resistant material and may have nominal mesh size of 4×4 mm with a strand diameter of about 0.5-1.0 mm.

In some embodiments, the fresh cementitious composition comprises mixture products of water, hydraulic cement, silicon dioxide powder, calcium oxide, iron oxide, plaster of Paris (gypsum hemihydrate), water-reducing agent, defoamer, styrene, and acrylic acid. The fresh cementitious composition may optionally include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The cementitious composition may include other components, such as natural hydraulic lime, calcium silicate, and/or expanded glass, which can increase fire and heat resistance.

In a more particular embodiment, the cementitious composition applied to the outer surfaces of the foam core to form fiber mesh reinforced cementitious layers of the lightweight composite panels can be formed by mixing together the following components (expressed in weight percent) to form a fresh flowable cementitious composition, which is applied to the foam core surfaces, together with fiber mesh, and then allowed to harden or cure:

| | |
|---|---|
| Hydraulic cement | 30-50% |
| Silicon dioxide | 40-60% |
| Calcium oxide | 2-5% |
| Iron oxide | 0.2-1% |
| Gypsum hemihydrate | 3-8% |
| Water-reducing agent | 0.2-0.6% |
| Defoamer | 0.2-0.6% |
| Styrene | 1-2% |
| Acrylic acid | 1-2% |
| Water | (16-20%, preferably 18.4% |
| | dry ingredients above) |

The hydraulic cement typically includes Portland cement clinker interground with gypsum for set control, but may also include other interground minerals, such as limestone filler (e.g., 5-10% by weight of the hydraulic cement), and optionally one or more supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The silicon dioxide can be 150 mesh ground quartz sand. The water reducer can be a low-range water reducer, such as a compound of carboxylic acid grafted multi-polymer and other effective additives. The defoamer can reduce the surface tension of water, solution, suspension, etc., prevent the formation of foam, or reduce or eliminate the original foam. The main component of the defoamer can be polydimethylsiloxane (Me₃SiO(Me₂SiO)nSiMe₃) (Me=methyl). In the case where very fine SCMs (e.g., silica fume, microsilica, or metakaoline), it may be desirable to use a high range water reducer (e.g., polycarboxylate ether) to obtain good flow. The styrene and acrylic acid components, which may be a copolymer, can form a chemical bond to the extruded polystyrene foam core, in addition to the physical bond.

The components of the cementitious composition can be mixed by high-performance mixing equipment through precise batching, and then fed into a mixing barrel in sequence for high-speed dispersion and mixing, thus yielding a fresh cementitious mixture. The fresh cementitious mixture is blended in a tank to make it into liquid or plastic form. The liquid cementitious mixture is then pumped into a machine variously called a “waterfall machine,” commonly known as a “curtain coater” or enrobing “coater/machine”, which has flow control of the liquid cementitious mixture and which will apply the liquid cementitious mixture onto surfaces of an extruded polystyrene foam sheet or other material to be coated. The liquid cementitious mixture is applied like a waterfall or curtain through a blade applicator to evenly apply it to the polymer foam surfaces or other surface to be coated. The product is then cured and left to stand for approximately 7 days as usual practice. However, if ambient conditions are dry and hot, the curing period could be shortened to approximately 3-4 days.

In general, the hardened fiber mesh reinforced cementitious composition can adhere and bond strongly to the polymer or inorganic foam core to form a strong lightweight composite panel structure that does not delaminate. The bond between the cementitious layers and the foam layer is likely a combination of physical and chemical interactions. When applied to the polymer or inorganic foam layer, the liquid cementitious composition can penetrate into surface pores of the foam layer, which upon hardening of the cementitious composition, forms a strong mechanical bond. This bond can be further enhanced through the inclusion of very fine pozzolans, such as silica fume, microsilica, or metakaoline on the cementitious composition, which creates a very high strength cementitious layer and are able to fill very small micropores. The polymer components of the cementitious composition may also interact with components of the foam layer to form a type of chemical bond between the cementitious layers and the foam (e.g., polymer) layer. Regardless of how bonding occurs, it is demonstrably very strong and does not delaminate during specified use. Curable resins also adhere and bond strongly to the foam core.

In some embodiments, when manufacturing the lightweight composite panel structure, the fiberglass mesh is first laid down on a polymer (e.g., extruded polystyrene) or inorganic foam sheet. A transportation belt then transports the foam sheet with the fiberglass mesh through the waterfall machine (commonly known as a “curtain coater” or enrobing “coater/machine”), which causes the liquid cementitious mixture to flow down like a waterfall or curtain, with control of the liquid cementitious mixture flow, onto the foam sheet or other substrate. In this way, the fiberglass mesh becomes embedded in the liquid cementitious mixture and essentially floats in the middle of the cementitious mixture. In other words, a portion of the liquid cementitious mixture will be positioned between the fiberglass mesh and the foam sheet in order to directly adhere to the foam sheet, and another portion of the liquid cementitious mixture will cover and encapsulate the fiber mesh to form the top surface of the lightweight composite panel structure. The result is a layered composite structure, with an interior polymer or inorganic foam sheet, an underlying layer of cementitious composition in direct contact with the foam sheet, a fiberglass mesh in the middle, and a top layer of cementitious composition covering the fiberglass mesh.

In addition to, or instead of, a fiber mesh reinformed cementitious layer, one or both protective layers of the lightweight composite panel may comprise other materials in addition to or instead of the cementitious composition. Examples include one or more of rigid magnesium oxide material, water-resistant polymer, or a composite material comprising a resin or polymer with embedded fibers, fiber mesh, fabric, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

Polyurea is a type of elastomer that is derived from the reaction product of an isocyanate component and an amine component. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin. The resin blend can include amine-terminated polymer resins and/or amine-terminated chain extenders. The resin blend may also contain additives or non-primary components, such as pigments pre-dispersed in a polyol carrier. Normally, the resin blend does not contain a catalyst. This is because the reaction between an isocyanate and amine is extremely fast and hence does not need catalysis.

The chemical structure of polyurea is as follows:

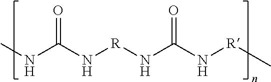

In a polyurea, alternating monomer units of isocyanates and amines react with each other to form urea linkages, as shown below.

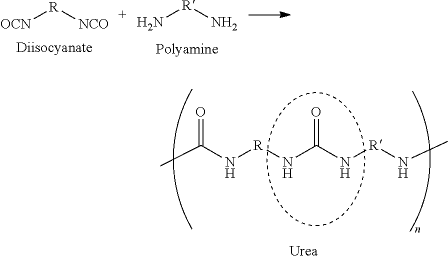

Polyaspartic resin is a solvent-free, aliphatic amine coating material based on aspartic acid, polyaspartic acid, or polyaspartic ester, which reacts with an isocyanate to create extremely durable protective coatings with rapid cure times, excellent abrasion resistance. An example of a curable polyaspartic resin has the following reactants and final cured polymer structure:

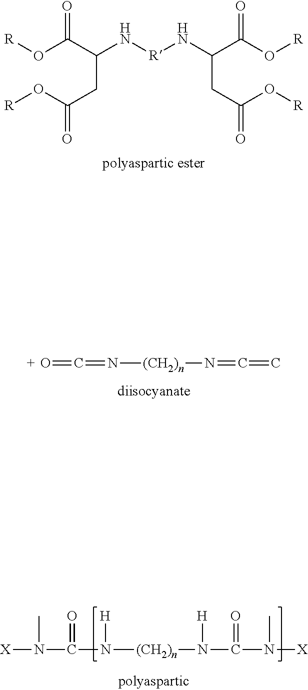

The curable resin can be applied by spray coating while in a flowable state to one or both surfaces of the foam core and allowing it to cure and form a solid protective layer. Multiple parts of the curable resin can be mixed just prior to entering or within the nozzle used to spray coat the foam core. Where it is desired to incorporate a fiberglass mesh sheet in the polymer layer, an initial coating of curable resin can be applied to the foam core, followed by applying the fiberglass mesh sheet over the resin, followed by applying a final coating of the curable resin.

In some embodiments, the outlines of the fiberglass mesh embedded within the hardened cementitious or cured resin layer can be visible and form a grid-like texture that improves adhesion of structural and/or decorative materials thereto, such as cementitious coatings, adhesives, stucco, paint, thin bricks, stone veneers, shingles, clay tiles, metal cladding, and the like. For example, one or more stucco layers can directly adhere to the fiber mesh reinforced cementitious layer without the need for wire mesh, scratch coat, and brown coat used in conventional stucco systems. Nevertheless, it may be desirable to apply a layer of thin set mortar to cover screws, sealants, holes, or other discontinuities in the lightweight composite panels prior to applying a finished stucco layer (which can be cementitious or acrylic based).

Additional information and features relating to lightweight composite panels and their uses in making various building products are disclosed in U.S. Prov. App. No. 63/686,489, filed Aug. 23, 2024; U.S. Prov. App. No. 63/692,563, filed Sep. 9, 2024; U.S. Prov. App. No. 63/703,834, filed Oct. 4, 2024; U.S. Prov. App. No. 63/720,649, filed Nov. 14, 2024; U.S. Prov. App. No. 63/729,637, filed Dec. 9, 2024; U.S. Prov. App. No. 63/744,115, filed Jan. 10, 2025; U.S. Prov. App. No. 63/747,543, filed Jan. 1, 2025; U.S. Prov. App. No. 63/753,600, filed Feb. 4, 2025; U.S. Prov. App. No. 63/764,354, filed Feb. 27, 2025; U.S. Prov. App. No. 63/788,276, filed Apr. 14, 2025; U.S. Prov. App. No. 63/849,709, filed Jul. 23, 2025, U.S. Prov. App. No. 63/855,715, filed Aug. 1, 2025, U.S. Prov. App. No. 63/857,807, filed Aug. 5, 2025, and U.S. Prov. App. No. 63/862,235, filed Aug. 12, 2025. The foregoing applications are incorporated by reference in their entirety.

The lightweight composite panels are typically rectangular in shape, with a constant cross sectional thickness. The lightweight composite panels can have multiple uses, including for interior walls that are exposed to moisture, providing a substrate to which tiles, stones, or other surface treatments can be applied, other interior walls (e.g., plaster coated composite panels), exterior sheathing that complements or replaces OSB panels, as a substrate for stucco, thin brick, natural or manufactured stone, or other finishes, roofing boards that function as underlayment for shingles, roofing tiles, metal roofing sheets, wood shakes, and the like, floor underlayment, ceiling panels, and shaft liners. The lightweight composite panels can be modified for specialized uses, such as by applying a decoupling layer, drainage plane, rain screen, dimple board, factory applied dimples or dots, or bleed layer to facilitate removal of moisture between the lightweight composite panels and exterior wall or roof structures.

The lightweight composite panels can include a polymer-modified cementitious coating layer, which facilitates adhesion of the cementitious layers to the foam core and also tiles or other surface finishes to an exposed composite panel surface. The fiberglass mesh embedded in the cementitious layers adds additional strength and rigidity to the overall composite structure of the lightweight composite panels. For uses contemplating application of tile or other products on an exposed surface, the lightweight composite panels can have a textured surface that facilitates application of adhesive/glue/cement to hold tiles and other products to the composite panel surface.

Advantages of the lightweight composite panels include: being lightweight (i.e., approximately ⅓ the weight of gypsum drywall and approximately ⅙ the weight of cement board); 100% waterproof as a result of the core being high density closed cell foam; high strength, high thermal insulation (i.e., proving approximately 4 times greater insulation than gypsum drywall), adequate soundproofing, and textured outer layer ideal for applying cement and glue for additional products. Further, due to the two layers of fiber reinforced cementitious composition, one on each side, a nail or screw entering both external layers can hold significant weight, substantially more weight than gypsum board.

Other advantages include the following:

Benefits from being Lighter Weight than Drywall:
a. delivery to site is cheaper; can ship 3 times more per truckload to the site;
b. easier to carry panels around job site because ⅓ the weight;
c. lower labor due to light weight; doesn't require two people to carry and hang panels.
   Benefit from being Waterproof:
a. no shrinkage from moisture on site (meaning if it rains on a pile of drywall awaiting use, they often have to throw away the top layer, or some of rest if water entered sides);
b. no mold risk, and less likely to have to be torn out and replaced if there is a leak in the house.
   Benefits from Just not being Dusty Gypsum:
a. Less likely to crack or break if dropped;
b. no gypsum dust.
   Benefits from Insulation:
a. four times higher R-value;
b. Some sound reduction.

### Stronger:

a. less likely to be damaged during construction transportation and handling;
b. advantages in roofing applications (discussed below);
c. performs as a structural panel for prescriptive braced walls or shear walls.

### Weather Resistant:

a. very low freeze and thaw deformation, rate of 0.014% (relevant to outdoor applications).

### III. Example Uses and Variations of Lightweight Composite Panels

The lightweight composite panels and variations thereof can be used in place of conventional wallboards and panels, including for a variety of uses such as interior drywall, backer boards for tile and other interior finishes, including those exposed to moisture, exterior wall sheathing and finishes applied thereto, floor underlayment, soffits, roofing decks and roof elements applied thereto, shaft liners, and the like.

The lightweight composite panels can be cut, drilled, and fastened to structural elements of buildings, such as wall frames comprising wooden or metal studs, roof frames comprising boards, studs, or trusses, floor joists, concrete floors, foundations, and the like. Because both sides comprise a fiber mesh reinforced cementitious composition, the lightweight composite panels are strong and can be nailed or screwed into and support relatively heavy loads, such as thin bricks, wall tiles, stone, stucco, roofing tiles, shingles, metal cladding, wood shakes, and other finishes applied thereto and/or fixtures or other items using nails, screws, or other fasteners known in the art.

In some embodiments, lightweight composite panels can be used as backing for exterior finishes, such as stucco, thin bricks, stone, or other finishes. In such cases, the lightweight composite panels for exterior use, including for application of a surface finish, can include a drainage layer, such as an uncoupling membrane, drainage plane, rain screen, dimple board, or bleed layer, which provides gaps and channels between the lightweight composite panels and the underlying building surface to permit moisture (e.g., from ingress or condensation) to collect, drain and/or evaporate, thereby protecting the outer surface finish, preventing formation of mold and mildew, and preventing structural damage to the underlying building wall and exterior surface finish.

The lightweight composite panels can be fastened to wall or roof structures of a building using mechanical fasteners and adhesives known in the art, such as wood screws, sheet metal screws, nails, rivets, and construction adhesive. Mechanical fasteners are advantageously corrosion resistant. Strips of tape can be used as a template to ensure proper placement of screws or other mechanical fasteners when fastening lightweight composite panels to studs or other structural elements of wall or roof structures.

To prevent screws from tearing through the exterior fiber mesh reinforced cementitious layer, screws can be used with enlarged washers having high surface area to distribute the pressure or load over a high surface area of the lightweight composite panels. Specialized washers with penetrating prongs can be used (e.g., with screws) to limit rotation and penetration, preventing damage to the lightweight composite panels. Rectangular washers with multiple prongs on either side of the screw can be used to tie adjacent lightweight composite panels together. The penetrating prongs can have a length so that the washers lie flush with or just below the surface of the exterior fiber mesh reinforced cementitious layer. A patch coating can be applied over the washers to fill any indentations caused by the washers or other mechanical fasteners.

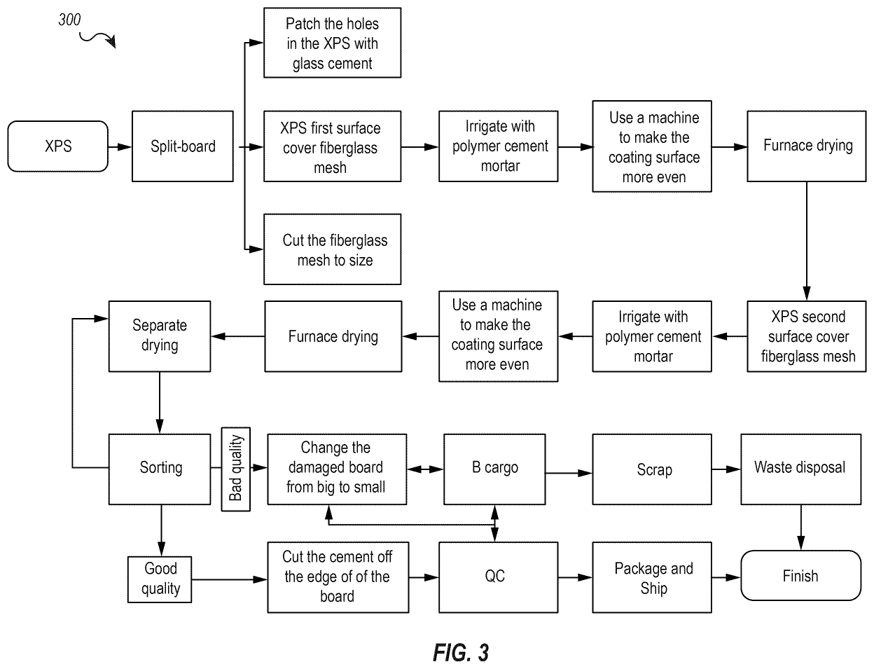

Reference is now made to FIGS. 4A-4C, which illustrate specialized washers with enlarged surface areas and penetrating prongs that help fix the washers in place relative to the lightweight composite panels, prevent rotation when screws are being driven into studs or other structural elements of a wall or roof frame, and add additional lateral strength between the washers and the lightweight composite panels. The penetrating prongs can also be designed to abut the underlying stud or other structural element and act as a stop to prevent the washers from being driven too far into the lightweight composite panels and undesirably crushing or fracturing the exterior fiber mesh reinforced cementitious layers, which could reduce the strength of an exterior wall structure or roofing deck.

FIG. 4A more particularly illustrates the use of a specialized fastener assembly 400 comprising a screw 402 and specialized washer 404 having a body 406 of enlarged diameter, a concave interior portion 408, and a plurality of penetrating prongs 410 extending laterally from the washer body 406. Although the specialized washer 404 in this embodiment is illustrated as having a circular washer body 406, other embodiments of specialized washers may include enlarged rectangular-shaped washer bodies (not shown) designed to more completely overlap and adjoin adjacent lightweight composite panels during installation.

The penetrating prongs 410 are designed to penetrate through and become embedded within a lightweight composite panel 420, including though the exterior fiber mesh reinforced layer 422, at least partially through the polymer foam core 424, and optionally through the interior fiber mesh reinforced layer 426 so as to make abutment with a stud 428 or other structural element of a wall or roof frame (not shown). The penetrating prongs 410 help retain the specialized washers 404 in a desired position relative to the lightweight composite panel 420 and prevent rotation while the screw 402 is being driven through the lightweight composite panel 420 and into the underlying stud 428 or other structural element of a wall or roof frame. The penetrating prongs 410 can also provide a load spreading/pressure spreading effect to distribute normal and lateral pressure from the screw 402 and washer body 406 to the prongs 410. The specialized washer 404 and penetrating prongs 410 provide greater lateral tension of the screw and washer assembly relative to the lightweight composite panel 420, thereby increasing the overall shear strength of a wall or roof structure.

FIG. 4B is a bottom perspective view and FIG. 4C is a top perspective view of the specialized washer 404, which more particularly illustrate features of the specialized washer 404. The washer body 406 can have an enlarged diameter in order to provide higher surface area and increase contact between the specialized washer 404 and an adjacent fiber reinforced cementitious layer of a lightweight composite panel. The washer body 406 can have a concave interior portion 408, which permits an outer rim 412 to become substantially flush with and the concave interior portion 408 to advance below the adjacent fiber reinforced cementitious layer when used to attach a lightweight composite panel to a wall or roof structure. This allows the concave interior portion 408 to partially compress the interior foam core 424 and exterior fiber reinforced cementitious layer 422 of the lightweight composite panel to provide firm and reliable attachment of the panel to the wall or roof structure. The washer body 406 can include a countersink 414 that accommodates the head 403 of the screw 402 so that the screw head 403 does not protrude beyond the surface of the washer body 406 when driven into a stud 428 or other structural element of a wall or roof frame.

The length of the penetrating prongs 410 can be selected to determine and limit how far the concave interior portion 408 of the washer body 406 is able to advance into and compress the lightweight composite panel 420. The penetrating prongs 410 can advantageously have a length in order to penetrate all the way through the lightweight composite panel 420 and make contact with the stud 428 or other structural element. In this way the penetrating prongs 410 can act as a stop that limits how far the specialized washer 404 can be driven toward and into the lightweight composite panel 420. Providing a stop prevents the specialized washer 404 from being driven too far into the lightweight composite panels 420, thereby preserving the structural integrity and strength of the exterior fiber mesh reinforced cementitious layer 422 adjacent to the specialized washer 404. This preserves and maximizes the overall strength, including shear strength, of the wall structure.

In some embodiments, it may be desirable for the length of the penetrating prongs 410 to be slightly less than the cross-sectional thickness of the lightweight composite panel 420 in order to superficially compress, but not damage, the exterior fiber mesh reinforced cementitious layer 422 toward the polymer foam core 424 to thereby increase the compressive force of the washer 404 bearing against the lightweight composite panel 420. This can increase the overall fixation strength of the fastening assembly 400.

In some embodiments, sealing one or more joints or seams between adjacent lightweight composite panels includes applying waterproof tape, metal flashing, polyurethane foam, fiber mesh tape and an appropriate seam coat (e.g., thin set mortar or fine sanded stucco), or other sealing means known in the over the joints or seams, including joints or seams in the wall or roofing deck face and corners. In addition, joints, seams, openings, or gaps between lightweight composite panels and other structural elements, such as wooden or metal beams or posts, vent pipes in roofs, fixtures, and the like, can be filled using sealing means known in the art, such as polyurethane foam, metal flashing, or tar.

In some embodiments, an appropriate seam coat can be applied over at least a portion of the exterior facing fiber mesh reinforced cementitious layer, including over any exposed screws, washers, or other mechanical fasteners used to attach the lightweight composite panels to the exterior wall or roof frame, and over any joints or seams, fiber mesh tape, polyurethane, or other exposed sealants on or in the exterior wall structure.

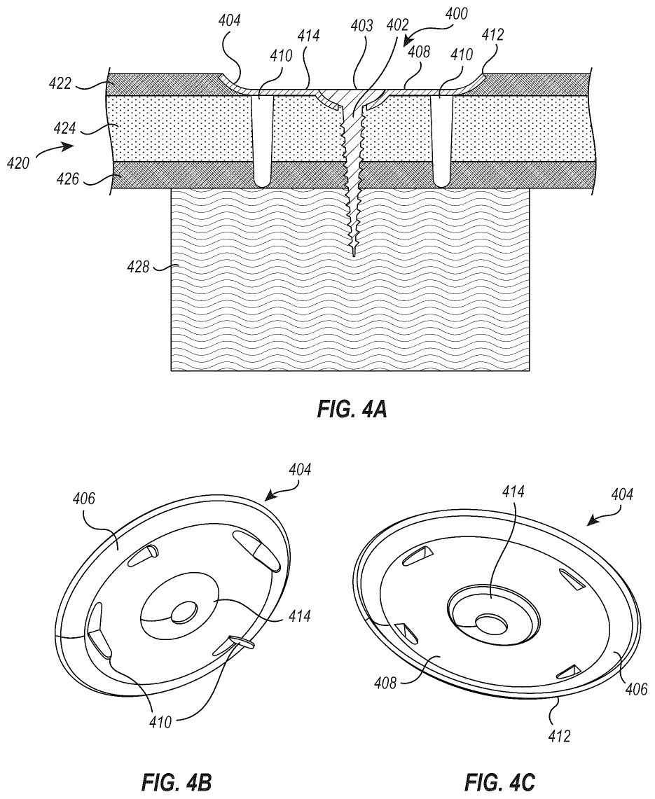

FIGS. 5A and 5B illustrate modified panels 500a, 500b for exterior use that includes a lightweight composite panel substructure 502 and a drainage layer 504a, 504b made of polymer or other material that provides a pathway for removal of moisture from between the modified panels 500a, 500b and an exterior wall (not shown). The drainage layers 504a, 504b can be called or referred to as an uncoupling membrane, drainage plane, rain screen, dimple board, or bleed layer. For purposes of this disclosure, they are collectively referred to as a “drainage layer”. The drainage layers 504a, 504b include physical gaps to promote drainage and removal of moisture that might otherwise collect between the lightweight composite panel 502 and the underlying wall or roof structure to which they are attached.

The drainage layers 504a, 504b can be attached to a surface of the lightweight composite panel substructure 502 using adhesives known in the art. In some embodiments, the drainage layers 504a, 504b can be adhered to the lightweight composite panel 502 using a standard polymer modified mortar, such as the cementitious composition used to form the outer surface layers of the lightweight composite panel substructure 502. The surface of the modified panels 500a, 500b opposite the drainage layers 504a, 504b can be a fiber mesh reinforced cementitious layer that can be used to apply a desired exterior surface finish, such as stucco, thin bricks, tiles, stone veneers, shingles, and the like. The modified panels 500a, 500b provide a waterproof exterior surface that also provides for moisture removal, such as to prevent growth of mold and mildew or structural damage to the underlying wall or roof structure.

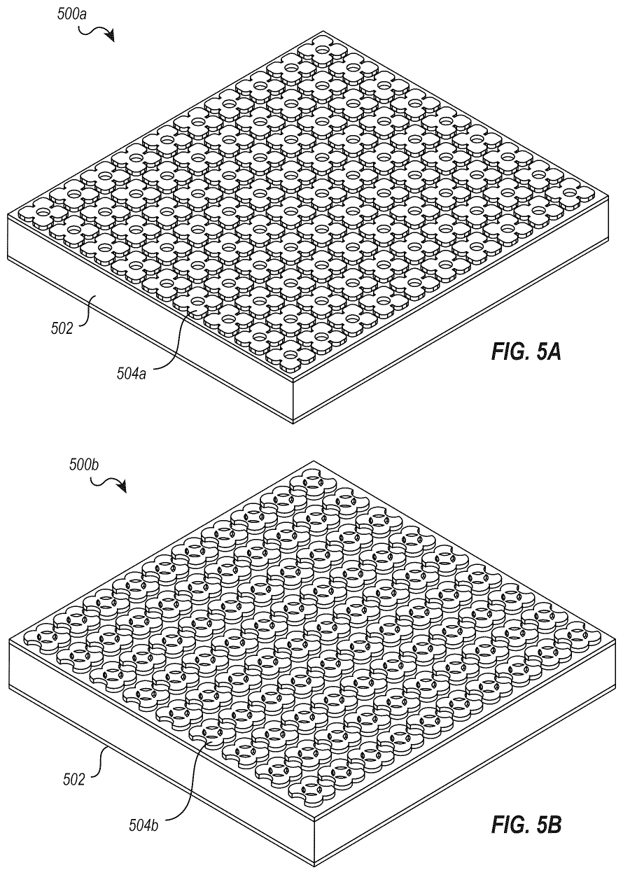

FIGS. 6A-6D illustrate alternative embodiments of drainage layers 600a, 600b, 600c, 600d, 600e that provide gaps or channels and that can be adhered to the interior side of a lightweight composite panel to create a modified panel to which an exterior surface finish, such as stucco, thin brinks, tiles, stone veneers, shingles, wood shakes, metal cladding, and like can be attached. The drainage layers 600a, 600b, 600c, 600d, 600e are not required to bear structural loads because the lightweight composite panels, having the strong composite structure described herein, can be screwed, nailed, glued, or otherwise secured to the underlying wall or roof structure so as to bear the entire load, including loads from applied exterior finishes, such as stucco, thin brick, stone, tiles, and the like. The only function of the drainage layers 600a, 600b, 600c, 600d, 600e is to provide gaps that facilitate removal of moisture from between an outer wall of a building and lightweight composite panels.

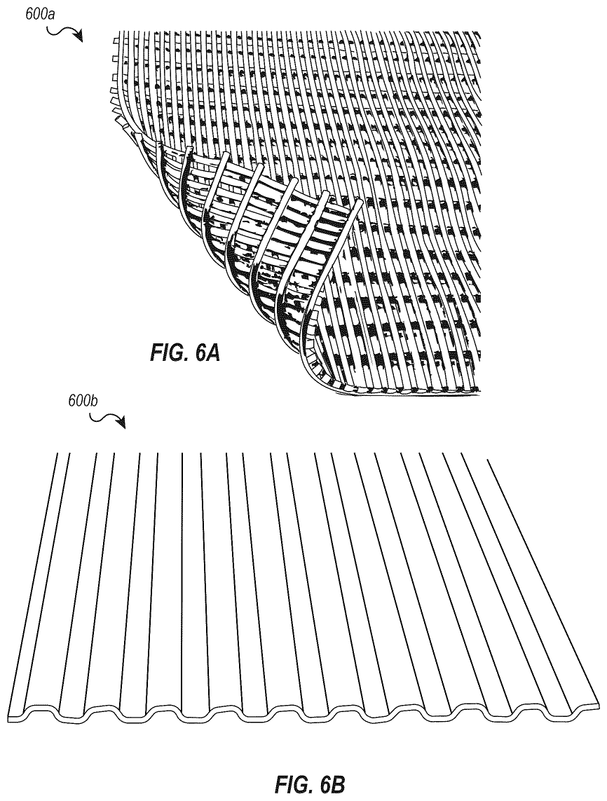

Reference is made to FIG. 7, which illustrates exterior building elements 700 attached to an underlying wall 702 of a building. They illustrate how a gap 704 is provided between the exterior building elements 700 and the underlying building wall 702. This gap 704 permits moisture that may have entered this region to be drained and/or evaporated away from the underlying building wall 702. FIG. 7 illustrates how condensed liquid water 706 can drain from the bottom of the gap 704 and how water vapor 708 can vent from the top of the gap 704.

In general, all drained enclosure systems, whether walls, basements, or roofs, are typically required to have a screen or cladding, a drainage gap (often a clear air space), a drainage plane (a water repellent plane), flashing at the base to direct water outwards, and drain holes (weep holes) to allow water out of the drainage gap. Water flows down under the force of gravity clinging to a surface, e.g., the interface between the back of the cladding and the airspace or the interface between roofing paper and a roof shingle. It has been shown that water can drain through very small gaps (e.g., 1-2 mm), even the small gap between two sheets of building paper.

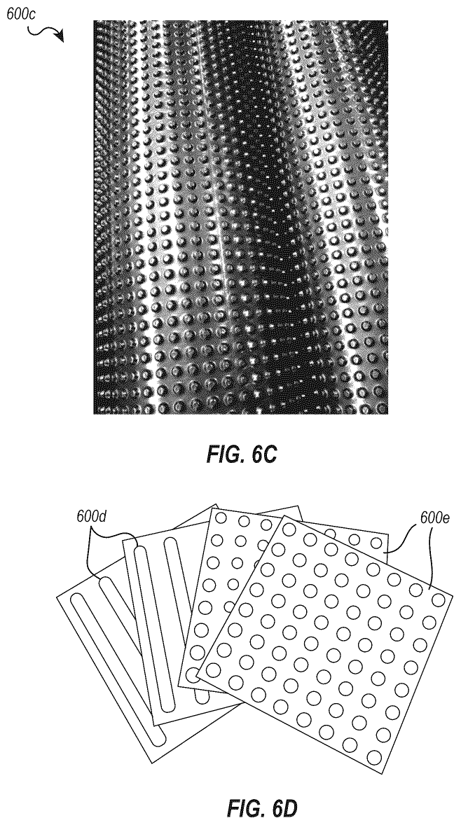

FIG. 8 illustrates an example stucco system 800 that includes a lightweight composite panel 802, which includes an exterior-facing fiber mesh reinforced cementitious layer as a bonding substrate. The lightweight composite panel 802 can be fastened to a wall or roof structure (not shown) by means of screws 804. Two of the screws 804 are shown covered by a patch coat 806 (e.g., thin set mortar or fine-sanded stucco) to create a smooth surface. A stucco finish 808 is applied over the fiber mesh reinforced cementitious layer 802 and patch coat 806. Both cement-based stucco and acrylic stucco can readily adhere directly to the fiber mesh reinforced cementitious layer 802 and patch coat 806. A primer is typically not required when using acrylic-based stucco, although a primer can be used if desired. Any primer known in the art for acrylic-based stucco can be used. Alternatively, the stucco finish can be factory installed to form exterior sheathing with a pre-applied finish. In such case, the example stucco system 800 that includes a lightweight composite pane 802 can be attached to a wall or roof structure using an appropriate high strength adhesive in order to not damage the stucco finish.

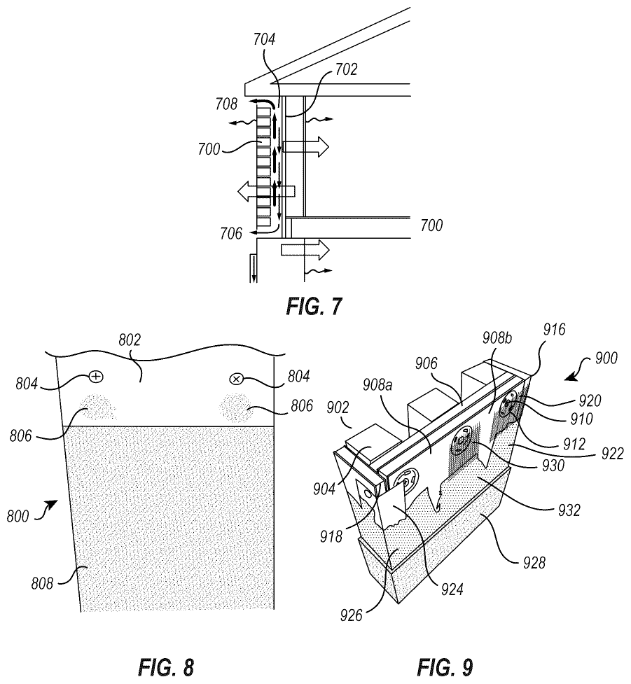

FIG. 9 is a perspective view of a mockup of another example stucco system 900 according to the disclosure. A difference between this embodiment and that of FIG. 8 is that the embodiment of FIG. 9 utilizes screws 910 pared with enlarged washers 912 to fasten a pair of adjacent lightweight composite panels 908a, 908b to the exterior wall structure 902, which is formed using studs 904 and an OSB sheath 906. A vertical concourse of screws 910 and enlarged washers 912 are used to interconnect adjacent lightweight composite panels 908a, 908b fastened to the OSB sheath 906. A vertical strip of fiber mesh tape 930 is placed over the vertical concourse of screws 910 and enlarged washers 912 and a portion of the exterior-facing fiber reinforced layers of the adjacent lightweight composite panels 908a, 908b, followed by applying a vertical strip of an appropriate seam coat (e.g., thin set mortar or fine-sanded stucco) 932 over the fiber mesh tape 930, screws 910 and enlarged washers 912, and a portion of the exterior-facing fiber reinforced layers to further tie the adjacent lightweight composite panels 908a, 908b together. This further helps prevent separation and potential formation of cracks in the stucco finish 928 at the joint between the adjacent lightweight composite panels 908a, 908b. The vertical strip of seam coat 932 also forms a more uniform surface to which the stucco finish 928 can be applied.

The example stucco system 900 also includes first and second corners 916, 918 formed between adjacent lightweight composite panels 908 positioned at 90° angles. The first corner 916 is protected by fiber mesh 920 and a first corner layer of an appropriate seam coat (e.g., thin set mortar or fine-sanded stucco) 922 in which the fiber mesh 920 is embedded. The second corner 918 is protected by a rigid metal corner bend 924, which can be made of galvanized steel, and a second corner layer of seam coat 926 covering the metal corner bend 924. It will be understood that the fiber mesh 920 and metal corner bend 924 are alternative embodiments and need not be included in the same embodiment. Rather, some embodiments may use the fiber mesh 920 and other embodiments may use the metal corner bend 924 (e.g., to provide greater protection against mechanical damage caused by blunt force to wall corners). One or more layers of stucco finish 928 (cement- or acrylic-based) is applied over the exterior-facing fiber mesh reinforced cementitious layers, vertical strip of seam coat 932, and first and second corner layers of seam coat 922, 926.

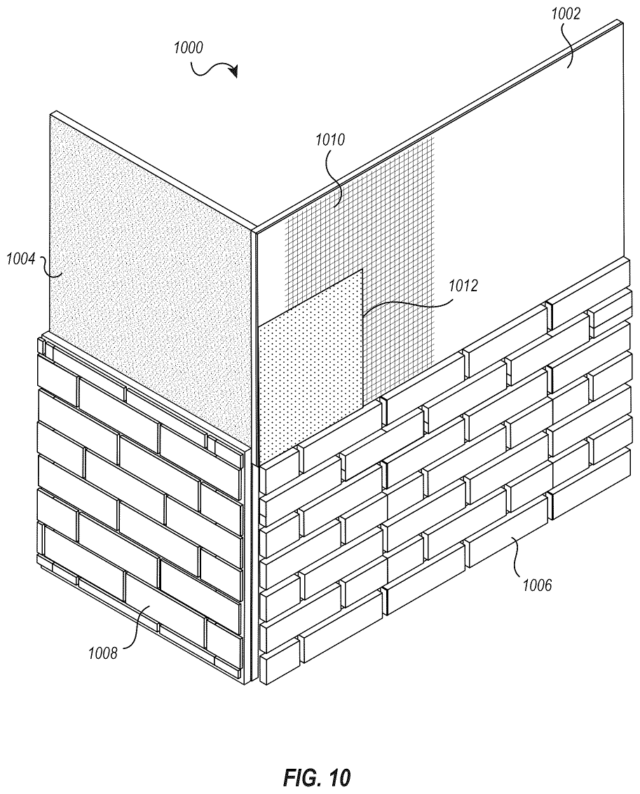

FIG. 10 illustrates an exterior wall 1000 that includes lightweight composite panel substrates 1002 attached over an exterior wall structure (not shown) and various exterior finishes applied to the lightweight composite panel substrates 1002. These include a stucco finish 1004, stone veneers 1006, and tiles 1008 applied over different portions of the lightweight composite panel substrates 1002. A layer of fiber mesh 1010 and a layer of an appropriate bonding layer 1012 (e.g., thin set mortar or fine-sanded stucco) covering the fiber mesh 1010 is applied over a portion of lightweight composite panel substrates 1002 to which the various finished are applied. The stucco finish 1004 (cement- or acrylic-based) can be applied directly over the bonding layer 1012. The stones veneers 1006 can be adhered to the bonding layer 1012 using thin set mortar (not shown) and/or an adhesive. The tiles 1008 can be adhered to the bonding layer 1012 using thin set mortar (not shown) and/or an adhesive.

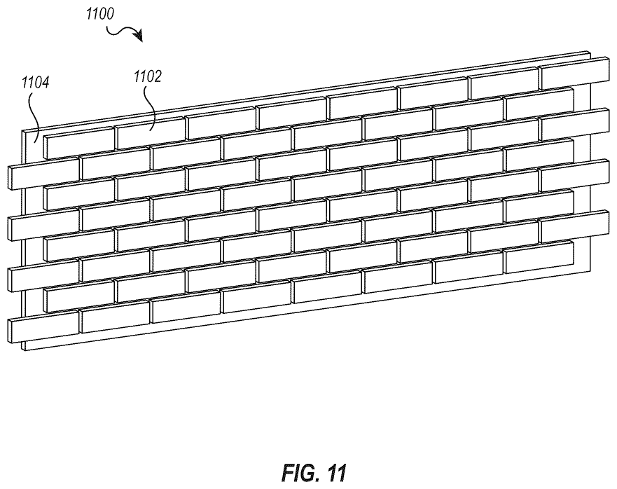

FIG. 11 illustrates exterior sheathing 1100 that includes thin bricks 1102 applied to an exterior surface of one or more lightweight composite panels 1104 to provide an exterior finish of a wall. The thin bricks 1102 can be factory installed to form exterior sheathing 1100 with a pre-applied finish, or they can be applied to the lightweight composite panels 1104 after placement on a wall or roof structure to form the exterior finish.

Another embodiment of the disclosed lightweight composite panels is their use as roof sheathing to form a roofing deck to which roofing tiles, shingles, metal cladding, and/or wood shakes can be applied to form a finished roof of a building. The lightweight composite panels have high strength and rigidity notwithstanding their low density and lightweight owing to the composite structure of the foam layer and the fiber mesh reinformed cementitious layers, which strongly adhere to the foam layer. A roofing system can include roofing joists, trusses to which lightweight composite panels are fixedly attached, such as by constructure adhesive, roofing screws, or roofing nails. The lightweight composite panels are sufficiently strong that they can support the weight of workers standing on top of the roof, as well as the finish roofing elements, when attached to roofing joists, trusses, and joints with typical spacing.

### ADDITIONAL TERMS & DEFINITIONS

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification are to be understood as optionally being modified by the term “about” or its synonyms. When the terms “about,” “approximately,” “substantially,” or the like are used in conjunction with a stated amount, value, or condition in the specification and claims, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A lightweight composite panel, comprising:
a polymer foam core having a first surface, a second surface opposite the first surface, a first side edge forming a perimeter of the first surface, a second side edge forming a perimeter of the second surface, and a side surface extending between the first and second side edges;
a first protective layer selected from a first fiber reinforced cementitious layer or first thermoset polymer layer formed over and covering at least a portion of the first surface of the polymer foam core; and
a second protective layer selected from a second fiber reinforced cementitious layer or second thermoset polymer layer formed over and covering at least a portion of the second surface of the polymer foam core,
wherein the first or second fiber reinforced cementitious layer, when included, comprises fiber reinforcement embedded within a hardened cementitious composition comprising reaction products of a fresh cementitious composition comprising water, Portland cement, silicon dioxide, calcium oxide, and gypsum hemihydrate,
wherein the first or second thermoset polymer layer, when included, comprises polyurea or polyaspartic and is optionally fiber-reinforced.

2. The lightweight composite panel of claim 1, wherein at least one of the first or second fiber reinforced cementitious layers is included, wherein the fresh cementitious composition comprises mixture products of water, hydraulic cement, silicon dioxide, calcium oxide, iron oxide, gypsum hemihydrate, water-reducing agent, defoamer, styrene, and acrylic acid or polymer thereof, and optionally at least one supplementary cementitious material (SCM) selected from the group consisting of ground granulated blast furnace slag (GGBFS), fly ash, natural pozzolan, silica fume, microsilica, metakaoline, ground glass, calcined clay, and finely ground quartz.

3. The lightweight composite panel of claim 2, wherein the fresh cementitious composition comprises mixture products of:

| | |
|---|---|
| hydraulic cement | 30-50% |
| silicon dioxide | 40-60% |
| calcium oxide | 2-5% |
| iron oxide | 0.2-1% |
| gypsum hemihydrate | 3-8% |
| water-reducing agent | 0.2-0.6% |
| defoamer | 0.2-0.6% |
| styrene | 1-2% |
| acrylic acid | 1-2% |
| water | 15-22% of dry ingredients. |

4. The lightweight composite panel of claim 3, wherein:
the fresh cementitious composition further comprises at least one of natural hydraulic lime, calcium silicate, or expanded glass;
the hydraulic cement comprises Portland cement, optionally interground with a mineral filler, optionally limestone;
the silicon dioxide comprises ground quartz sand, optionally 150 mesh;
the water-reducing agent comprises a carboxylic acid grafted multi-polymer; and
the defoamer comprises polydimethylsiloxane.

5. The lightweight composite panel of claim 1, wherein at least one of the first or second fiber reinforced cementitious layers is included and comprises fiber reinforcement selected from fiber mesh, alkali-resistant fiberglass mesh, embedded fibers, fabric, woven, scrim, felt, and non-woven, wherein the fiber reinforcement comprise at least one of plant fibers, polymer fibers, and inorganic fibers, which are selected from fibers or filaments formed from glass, basalt, rock wool, or carbon.

6. The lightweight composite panel of claim 5, wherein at least one of the first or second fiber reinforced cementitious layers has a cross-sectional thickness in a range of about 0.5 mm to about 3 mm, or about 0.75 mm to about 2.5 mm, or about 1 mm to about 2 mm, or about 1.25 mm to about 1.75 mm.

7. The lightweight composite panel of claim 5, wherein the first or second fiber reinforced cementitious layer has a textured exterior surface.

8. The lightweight composite panel of claim 1, wherein at least one of the first or second thermoset polymer layers is included and has a cross-sectional thickness in a range of about 1 mm to about 5 mm, or about 2 mm to about 4 mm.

9. The lightweight composite panel of claim 1, wherein the lightweight composite panel is substantially flat or planar.

10. The lightweight composite panel of claim 1, wherein the first and second protective layers are mechanically and/or chemically bonded, respectively, to the first and second surfaces of the polymer foam core.

11. The lightweight composite panel of claim 1, wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure.

12. The lightweight composite panel of claim 1, further comprising a finish on or applied to the first or second fiber mesh reinforced cementitious layer, wherein the finish is selected from the group consisting of thin bricks, wall tiles, stone, stucco, roofing tiles, shingles, metal cladding, wood shakes, and combinations thereof.

13. A lightweight composite panel, comprising:
a polymer foam core having a first surface, a second surface opposite the first surface, a first side edge forming a perimeter of the first surface, a second side edge forming a perimeter of the second surface, and a side surface extending between the first and second side edges;
a first protective fiber mesh reinforced cementitious layer formed over and covering at least a portion of the first surface of the polymer foam core; and
a second protective fiber mesh reinforced cementitious layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein each of the first and second protective fiber mesh reinforced cementitious comprises fiberglass mesh embedded within a hardened cementitious composition comprising reaction products of a fresh cementitious composition comprising water, Portland cement, silicon dioxide, calcium oxide, and gypsum hemihydrate.

14. A lightweight composite panel, comprising:
a polymer foam core having a first surface, a second surface opposite the first surface, a first side edge forming a perimeter of the first surface, a second side edge forming a perimeter of the second surface, and a side surface extending between the first and second side edges;
a first protective thermoset polymer layer formed over and covering at least a portion of the first surface of the polymer foam core; and
a second protective thermoset polymer layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein the first and second thermoset polymer layers are independently selected from polyurea and polyaspartic and are optionally fiber-reinforced.

15. A method of manufacturing a lightweight composite panel as in claim 1, comprising:
providing the polymer foam sheet having a first surface, a second surface opposite the first surface, a first side edge forming a perimeter of the first surface, a second side edge forming a perimeter of the second surface, and a side surface extending between the first and second side edges;
forming the first protective layer selected from a fiber reinforced cementitious layer or thermoset polymer layer over to cover at least a portion of the first surface of the polymer foam sheet; and
forming the second protective layer selected from a fiber mesh reinforced cementitious layer or thermoset polymer layer over to cover at least a portion of the second surface of the polymer foam sheet,
wherein the first or second fiber reinforced cementitious layer, when included, comprises fiber reinforcement embedded within a hardened cementitious composition comprising reaction products of a fresh cementitious composition comprising water, Portland cement, silicon dioxide, calcium oxide, and gypsum hemihydrate,
wherein the first or second thermoset polymer layer, when included, comprises polyurea or polyaspartic and is optionally fiber-reinforced.

16. The method of claim 15, wherein:
at least one of the first or second fiber mesh reinforced cementitious layer is included and formed by applying a fiber sheet or mesh over a first or second surface of the polymer foam sheet, applying the fresh cementitious composition over the fiber mesh or sheet in order to contact the first or second surface of the polymer foam sheet and embed the fiber sheet or mesh within the fresh cementitious composition, and causing or allowing the fresh cementitious composition to harden,
wherein the fresh cementitious composition comprises mixture products of water, hydraulic cement, silicon dioxide, calcium oxide, iron oxide, gypsum hemihydrate, water-reducing agent, defoamer, styrene, and acrylic acid or polymer thereof.

17. The method of claim 16, wherein the fresh cementitious composition comprises mixture products of:

| | |
|---|---|
| hydraulic cement | 30-50% |
| silicon dioxide | 40-60% |
| calcium oxide | 2-5% |
| iron oxide | 0.2-1% |
| gypsum hemihydrate | 3-8% |
| water-reducing agent | 0.2-0.6% |
| defoamer | 0.2-0.6% |
| styrene | 1-2% |
| acrylic acid | 1-2% |
| water | 15-22% of dry ingredients. |

18. The method of any one of claim 15, wherein the fresh cementitious composition is applied by a waterfall machine or procedure, curtain coater, or enrobing coater/machine.

19. The method of any one of claim 15, wherein:
at least one of the first or second thermoset polymer layers is included and formed by spray coating one or more layers of a curable resin to the first or second surface of the polymer foam sheet, optionally with a fiber sheet or mesh between first and second layers of the curable resin, and causing or allowing the curable resin to cure.

20. The method of any one of claim 15, further comprising smoothing the applied fresh cementitious composition before causing or allowing it to harden, and optionally cutting or trimming excess material from the lightweight composite panel.
